(19) United States
(12) Patent Application Publication
(10) Pub. No.: US 2004/0085702 A1
(43) Pub. Date: May 6, 2004

(54) Thermal overcurrent relay

(76) Inventor: Hideaki Ohkubo, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/472,938

(22) PCT Filed: Mar. 28, 2002
(86) PCT No.: PCT/JP02/03085

(51) Int. Cl. H01H 47/26

(52) U.S. Cl. 361/161

(57) ABSTRACT

A thermal overcurrent relay includes a bimetal curved according to a primary circuit current, an interlocking plate for transmitting a displacement of the bimetal, an adjusting lever supported by a shaft protruding from a case, freely rotating in a predetermined range according to a range of the primary circuit current capable of being used, an operation lever supported by the adjusting lever, rotated by a force given from the interlocking plate, acting on an inverting mechanism section to invert an opening and closing state of a contact, and an adjusting knob for changing a distance of the displacement of the interlocking plate necessary for the start of inversion, wherein the support shaft of the adjusting lever is a substantially sectorial protrusion, the sectional profile of which has a central angle open to an inner wall of the case existing in the proceeding direction of the interlocking plate, and the adjusting lever has a substantially sectorial shaft hole, which is inserted into the support shaft, having an angle larger than the central angle of the support shaft.

### TECHNICAL FIELD

The present invention relates to an operating current adjusting mechanism of a thermal overcurrent relay used for protecting a motor and others from being overloaded.

### BACKGROUND ART

For example, Japanese Patent No. 2880848 discloses a conventional thermal overcurrent relay (thermal relay).

In the same manner, FIG. 18 shows a conventional thermal overcurrent relay. This type thermal overcurrent relay includes a bimetal 2 curved according to an intensity of a main circuit current, an interlocking plate 4 coming into contact with a forward end of the bimetal 2 so that a displacement of the bimetal 2 can be transmitted to the interlocking plate 4, an adjusting lever 7A supported by a shaft 1za protruding from the case 1, capable of being freely rotated round the shaft 1za in a predetermined range according to a usable intensity of the main circuit current, an operation lever 6 supported by the adjusting lever 7A, rotated by a force given from the interlocking plate 4, acting on an inverting mechanism section for inverting an opening and closing state of a contact, and an adjusting knob 8 having an eccentric cam section 8a coming into contact with the adjusting lever 7A, wherein the distance from the rotational center of the eccentric cam section 8a to the contacting portion with the adjusting lever 7A is gradually reduced.

When the operation lever 6 is rotated, the inverting mechanism section is pushed. When the inverting mechanism section is pushed by a predetermined quantity of pushing, the opening and closing state of the contact is inverted.

This quantity of pushing of the inverting mechanism section is determined by the total of a quantity of rotation of the adjusting lever 7A and a quantity of rotation of the operation lever 6.

Accordingly, when the adjusting knob 8 is rotated so that a contacting distance between the eccentric cam section 8a and the adjusting lever 7A is changed and a rotational range of the adjusting lever 7A is restricted, a quantity of displacement of the bimetal 2 required for inverting an opening and closing state of the contact can be adjusted.

In the above thermal overcurrent relay, a difference in the size between the adjusting lever support shaft 1za and the shaft hole 7Aa so that both can be rotated without causing interference with each other.

For example, as shown in FIG. 19A, in the case where the support shaft 1za is a column and the shaft hole 7Aa is a circle, the adjusting lever jounces in the vertical and the horizontal direction as shown in FIGS. 20A to 20C due to a difference between the diameter of the support shaft column and the diameter of the shaft hole circle. Further, as shown in FIGS. 21A and 21B, jounce is caused in such a manner that an upper portion and a lower portion of the adjusting lever 7A are tilted from each other.

When jounce is caused by the difference in the size between the support shaft 1za and the shaft hole 7Aa as described above, the following problems may be encountered. Since the adjusting lever 7A can not be stably positioned, a rotational center (7Ah) of the operation lever 6, which is supported by the adjusting lever 7A, is shifted, and a quantity of displacement of the trip motion rotated by a force given from the interlocking plate 4 can not be stabilized. Therefore, it becomes difficult to open and close the contact by a targeted quantity of displacement of the bimetal. Further, an opening and closing point of the contact is changed for each operation, that is, the operation property fluctuates.

Further, the following problems may be encountered. When the adjusting lever 7A is excessively rotated counterclockwise in FIG. 18, the operation lever 6 is rotated as a fulcrum of the contacting section of the interlocking plate 4 and the ambient temperature compensating bimetal 5 which is integrated with the operation lever 6. Therefore, an excessively strong force is given to the operation plate 11, and the operation plate 11 is deformed and the opening and closing point of the contact is changed, which causes fluctuation of the operation property.

When an inclination of the adjusting lever support shaft 1za is changed by the influence of a force and heat, the position of the adjusting lever 7a is changed each time. Accordingly, the opening and closing point of the contact is changed, that is, the operation property is changed.

In the case where the rib 1zr is provided so that the adjusting lever support shaft 1za can not be inclined as shown in FIG. 19B, it is necessary to provide a cutout portion in at least one of the two plates composing the adjusting lever 7A. When this cutout portion is too small, the adjusting lever 7A interferes with the rib 1zr, and rotation of the adjusting lever 7A is restricted. When this cutout portion is too large, one of the plates of the adjusting lever 7A is put into a state in which the plate freely comes out to right in FIG. 18.

Therefore, the following problems may be encountered. When the adjusting lever is rotated, it tends to be twisted, and the adjusting lever 7A is inclined by a difference in the size between the adjusting lever support shaft 1za and the adjusting lever shaft hole 7Aa. Then, a rotational shaft of the operation lever 6 supported by the adjusting lever 7A does not become parallel with the adjusting lever support shaft 1za. Accordingly, the operation lever 6 is not rotated on a plane perpendicular to the adjusting lever support shaft 1za, and it becomes difficult to open and close the contact by a targeted quantity of the displacement of the bimetal. When an inclination of the adjusting lever 7A is changed at each motion, the opening and closing point of the contact changes each time, that is, the operation property fluctuates.

Further, the following problems may be encountered. In the case where the contacting portion of the adjusting lever 7A with the eccentric cam section 8a of the adjusting knob 8 is located at a position deviating on either side of the two plates composing the adjusting lever 7A, when a force is given by the interlocking plate 4 under the condition that the adjusting lever 7A comes into contact with the eccentric cam section 8a, the direction of the force is not perpendicular to the adjusting lever support shaft 1za but the direction of the force is inclined by a quantity of deviation of the contacting section.

Therefore, the adjusting lever 7A is inclined by a difference in the size between the adjusting lever support shaft 1za and the adjusting lever shaft hole 7Aa, and the rotational shaft of the operation lever 6 supported by the adjusting lever 7A does not become parallel with the adjusting lever support shaft 1za. Therefore, rotation of the operation lever 6 is not conducted on a plane perpendicular to the adjusting lever support shaft 1za. Accordingly, it becomes difficult to open and close the contact by a targeted quantity of displacement of the bimetal. Further, when an inclination of the adjusting lever 7A becomes different for each operation, an opening and closing point of the contact changes each time, that is, the operation property fluctuates.

Further, the following problems may be encountered. The adjusting lever 7A is composed in such a manner that the contacting position of the adjusting lever 7A with the eccentric cam section 8a of the adjusting knob 8 is at the lower end portion of the adjusting lever 7A in one state as shown in FIG. 22A and the contacting position of the adjusting lever 7A with the eccentric cam section 8a of the adjusting knob. 8 is at the upper end portion of the adjusting lever 7A in the other state as shown in FIG. 22B in a predetermined rotating range of the adjusting lever 7A. That is, the adjusting lever 7A comes into contact with the eccentric cam section 8a of the adjusting knob 8 discontinuously in the above two states. Therefore, in the predetermined rotational range of the adjusting lever 7A, the contacting position can not be stabilized in the range shown by θng in FIG. 22C. Therefore, the operation property greatly fluctuates in the range shown by θng in FIG. 22C.

On the other hand, in the thermal overcurrent relay (thermal relay) disclosed in Japanese Patent No. 2880848, an operation current is adjusted by substantially C-shaped adjusting levers which are composed in parallel with each other supported by a columnar shaft rib protruding onto the inner circumferential face of the case. However, the above patent does not disclose any operating current adjusting mechanism of high accuracy which dose not cause any fluctuation of the operation property originated from non-stability of the position of the adjusting lever.

### DISCLOSURE OF THE INVENTION

The present invention has been accomplished to solve the above conventional problems. It is an object of the present invention to provide a thermal overcurrent relay provided with a highly accurate operating current adjusting mechanism in which no fluctuation is caused in the operation property.

In order to accomplish the above object, according to the first viewpoint, the present invention provides a thermal overcurrent relay including a bimetal curved according to a primary circuit current, an interlocking plate for transmitting a displacement of the bimetal, an adjusting lever supported by a shaft protruding from a case, freely rotating in a predetermined range according to a range of the primary circuit current capable of being used, an operation lever supported by the adjusting lever, rotated by a force given from the interlocking plate, acting on an inverting mechanism section to invert an opening and closing state of a contact, and an adjusting knob for changing a distance of the displacement of the interlocking plate necessary for the start of inversion, wherein the support shaft of the adjusting lever is a substantially sectorial protrusion, the sectional profile of which has an acute central angle open to an inner wall of the case existing in the proceeding direction of the interlocking plate, and the adjusting lever has a substantially sectorial shaft hole, which is inserted into the support shaft, having an angle larger than the central angle of the support shaft.

A sectional profile of the adjusting lever support shaft is a sector, in the central angle portion of which an arc of a minute radius is formed, and the adjusting lever support shaft comes into contact with an inner wall face of a shaft hole of the adjusting lever at two points on the arc of the minute radius.

The adjusting lever is formed into a substantial C-shape composed of two plates, which are perpendicular to the support shaft, and one connecting plate to connect the two plates in such a manner that the connecting plate crosses the two plates, and the two plates of the adjusting lever inserted into the support shaft respectively have a substantially sectorial shaft hole.

A difference between the central angle of the adjusting lever support shaft and the central angle of the shaft hole is approximately the same as the angle of the predetermined rotating range of the adjusting lever according to the range of the usable primary circuit current.

The adjusting lever support shaft protruding from the case is connected with the inner wall of the case except for an upper portion of the support shaft by a rib, the width of which is smaller than the diameter of the adjusting lever support shaft protruding from the inner wall of the case existing in the proceeding direction of the interlocking plate, the engaging portion of the plate close to the root of the adjusting lever support shaft with the support shaft is formed into a reverse C-shape having a cutout portion, the size of which is larger than the width of the rib connected with the support shaft and smaller than the diameter of the support shaft, and the adjusting lever does not interfere with the rib even when the adjusting lever makes a predetermined rotation according to the range of the usable primary circuit current and the adjusting lever always has a hook portion at which the support shaft is hooked.

The contacting portion of the adjusting lever with the adjusting knob is located at a substantial center between the two plates composing the adjusting lever perpendicular to the adjusting lever support shaft.

An arc portion is formed on the contacting portion with the adjusting knock formed on the end portion of the adjusting lever, and the adjusting lever is composed so that it can be always contacted with the eccentric cam portion of the adjusting knob at any one of the arc portion in a predetermined rotational range of the adjusting lever.

### BRIEF DESCRIPTION OF THE DRAWINGS

FIG. 1 is a view showing an internal structure of the thermal overcurrent relay of the present invention.

FIG. 2 is a sectional side view of the thermal overcurrent relay of the present invention.

FIGS. 3A to 3D are views showing the structure of a primary circuit terminal on the electric power supply side, a primary circuit terminal on the load side and a bimetal.

FIG. 4 is a view showing an appearance of the terminal section of the thermal overcurrent relay.

FIG. 5 is an arrangement view showing an internal structure of the thermal overcurrent relay in detail.

FIG. 6 is an arrangement view showing an internal structure of the thermal overcurrent relay in detail.

FIG. 7 is an arrangement view showing an internal structure of the thermal overcurrent relay in detail.

FIGS. 8A and 8B are constitution views showing an adjusting lever support shaft and an adjusting lever.

FIG. 9 is an arrangement view showing the structure of a rotary lever.

FIG. 10 is an arrangement view showing an internal structure of the thermal overcurrent relay in detail.

FIG. 11 is an arrangement view showing an internal structure of the thermal overcurrent relay in detail.

FIGS. 12A and 12B are arrangement views showing the structure of a reset bar case.

FIGS. 13A to 13D are constitution views showing a contacting relation of between the arc at the acute angle end portion of the adjusting lever support shaft and the inner wall V-shaped portion of the adjusting lever shaft hole.

FIG. 14 is a view showing a positional relation among the adjusting lever, the adjusting knob and the operation lever.

FIGS. 15A and 15B are constitution views showing an adjusting lever support shaft and an adjusting lever.

FIGS. 16A to 16B are arrangement views showing an adjusting lever.

FIG. 17 is a view showing the internal structure of a conventional thermal overcurrent relay.

FIG. 18 is a view showing a contacting position relation between the adjusting lever and the eccentric cam section of the adjusting knob.

FIGS. 19A and 19B are views showing the structure of a conventional adjusting lever support shaft.

FIGS. 20A to 20C are constitution views showing a positional relation between the conventional adjusting lever support shaft and the adjusting lever shaft hole.

FIGS. 21A and 21B are constitution views showing a positional relation between the conventional adjusting lever support shaft and the conventional adjusting lever shaft hole.

FIGS. 22A to 22C are views showing a contacting position relation of the contact of the conventional adjusting lever with the eccentric cam section of the adjusting knob.

### BEST MODE FOR CARRYING OUT THE INVENTION

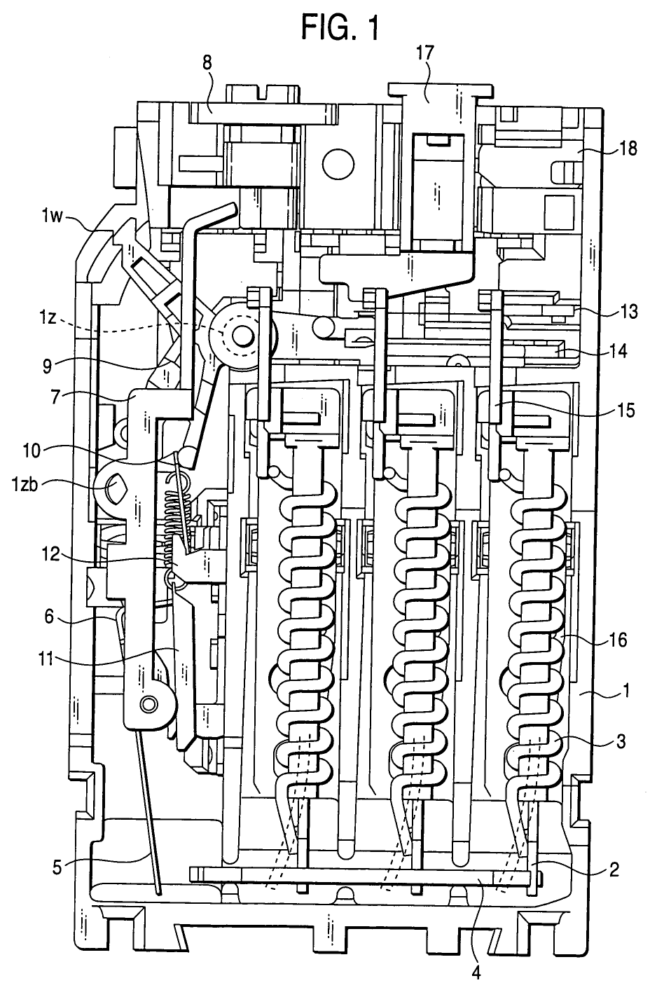

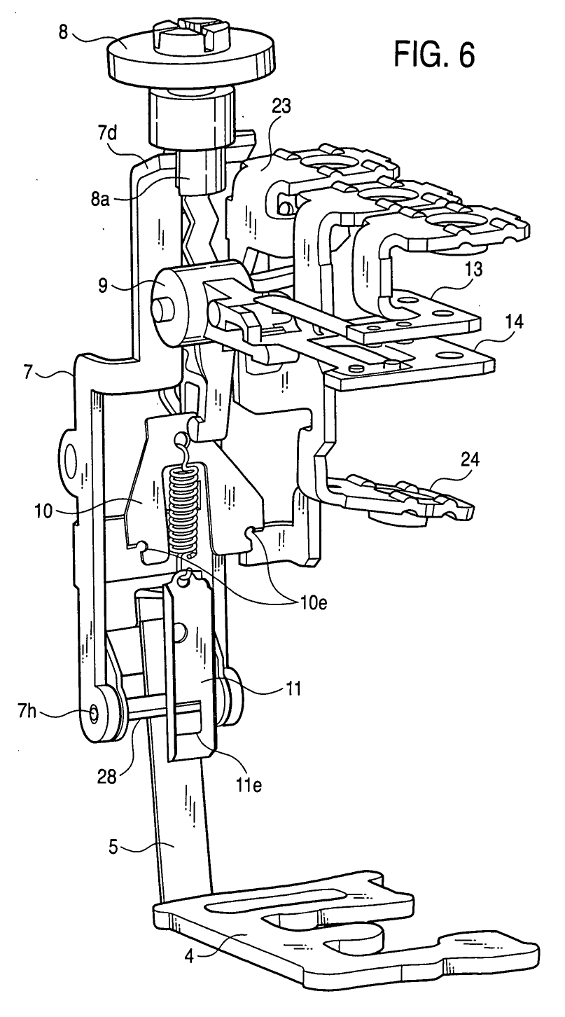

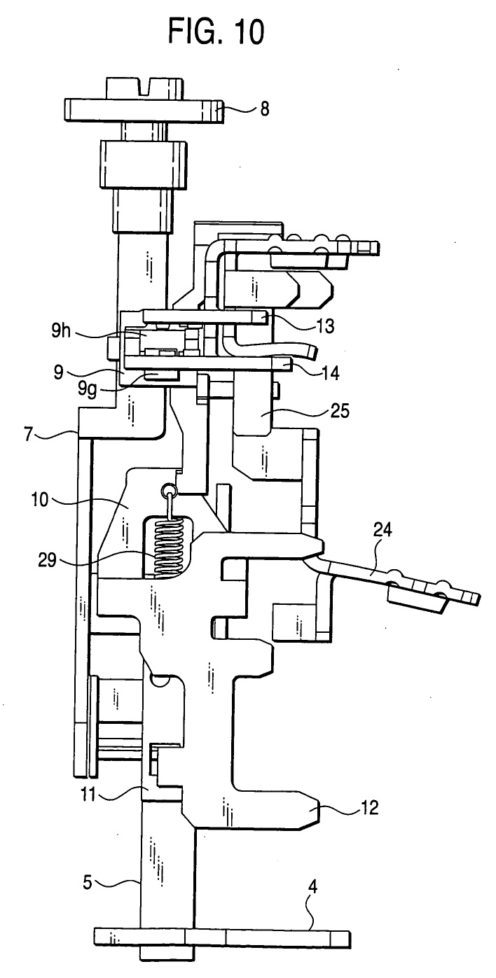

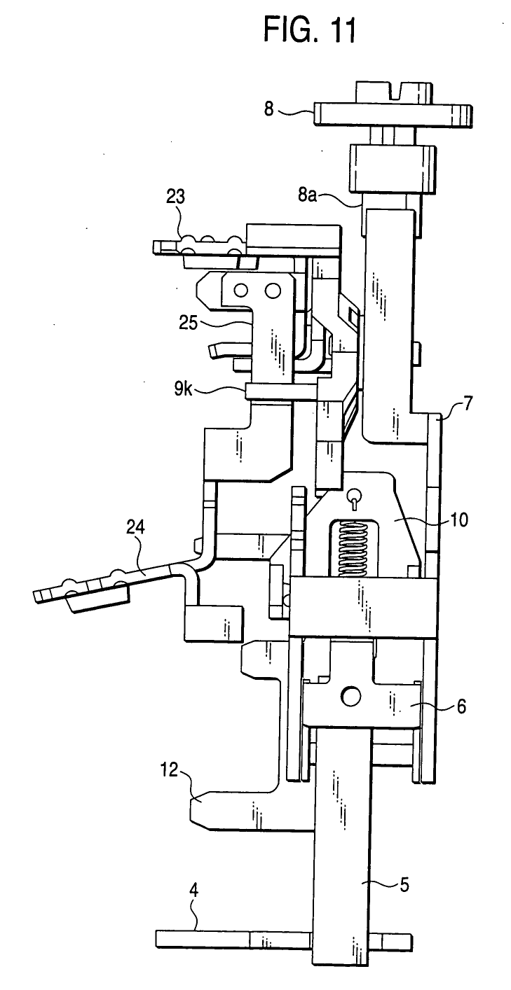

Referring to FIGS. 1 to 14, an embodiment of the thermal overcurrent relay of the present invention will be explained below.

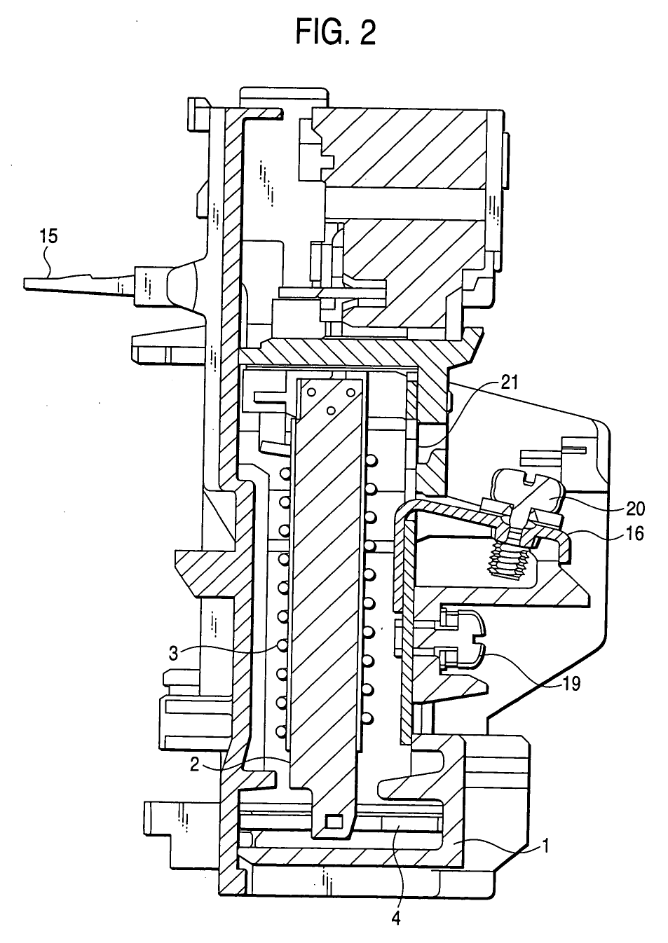

FIG. 1 is a view showing an internal structure of the thermal overcurrent relay of the present invention, and FIG. 2 is a sectional side view of the thermal overcurrent relay of the present invention.

In the views, reference numeral 1 is a case, and reference numeral 2 is a bimetal curved according to a primary circuit current, wherein this bimetal is arranged for each phase. When this bimetal 2 is heated by the heater 3 in which the primary circuit current flows, the bimetal is deformed being curved to left in the view as shown by the broken line.

Reference numeral 4 is an interlocking plate coming into contact with an end portion of the bimetal 2 so that a displacement of the bimetal 2 can be transmitted by the interlocking plate 4. The interlocking plate 4 comes into contact with an end portion of each bimetal 2. According to a quantity of the curve of the bimetal 2, the interlocking plate 4 is moved to left in FIG. 1, and a left end portion of the interlocking plate 4 pushes a lower end portion of the ambient temperature compensation bimetal 5.

Reference numeral 5 is an ambient temperature compensation bimetal, reference numeral 6 is an operation lever supported by the adjusting lever 7, rotated by a force given from the interlocking plate 4 so that the inverting mechanism section to invert an opening and closing state of the contact can be operated, reference numeral 7 is an adjusting lever supported by the shaft 1zb protruding from the case 1, freely rotating in a predetermined range according to the usable range of the primary circuit current, reference numeral 8 is an adjusting knob having an eccentric cam section 8a coming into contact with the adjusting lever 7, wherein the distance from the rotational center of the eccentric cam section 8a to the contacting portion with the adjusting lever 7 is gradually reduced, reference numeral 9 is a substantially Y-shaped rotary lever, the central cylindrical portion 9a of which is inserted into the protruding shaft 1z provided in the case 1 so that rotary lever is pivotally held, reference numeral 10 is an inversion plate, reference numeral 11 is an operation plate, reference numeral 12 is an inverting mechanism support member, reference numeral 13 is a terminal on the fixing side, which is always open, press-fitted into the case 1, reference numeral 14 is a terminal on the movable side, which is always open, press-fitted into the case 1, reference numeral 15 is a primary circuit terminal on the electric power supply side, reference numeral 16 is an L-shaped primary circuit terminal on the load side, reference numeral 17 is a reset bar to conduct a reset operation, reference numeral 18 is a changeover plate to change over the reset operation between manual operation and automatic operation, reference numeral 19 is a fastening screw, and reference numeral 20 is a terminal screw used for connecting the primary circuit (external circuit) on the load side.

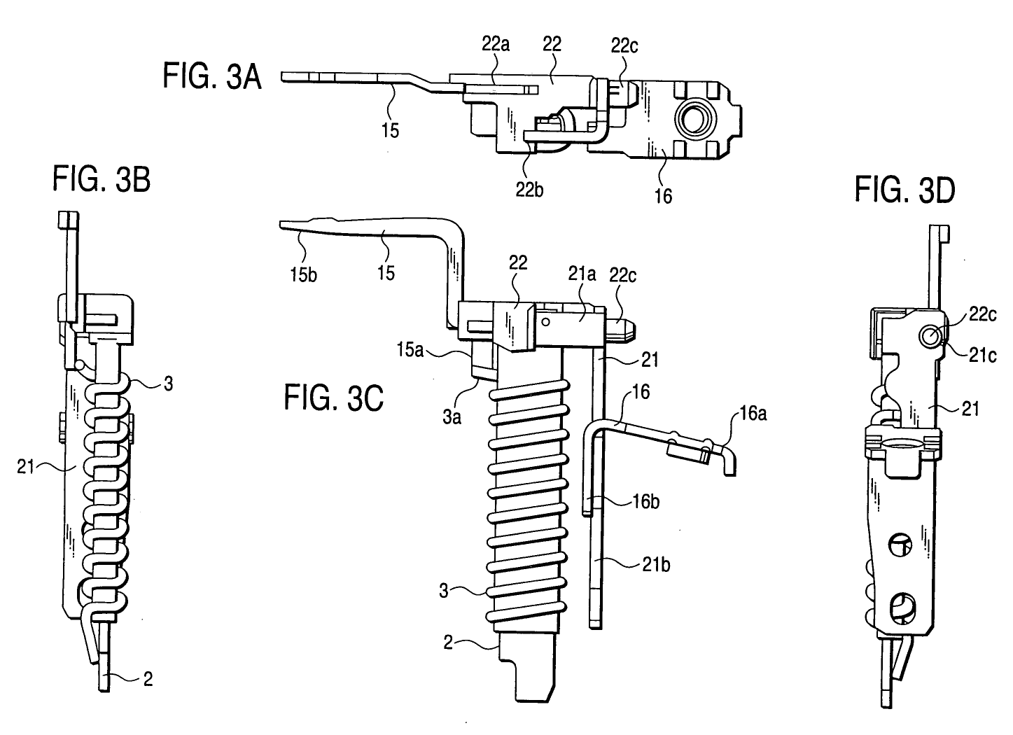

FIGS. 3A to 3D are views showing the structure of a primary circuit terminal on the electric power supply side, a primary circuit terminal on the load side and a bimetal. In the views, concerning the primary circuit terminal 16 on the load side, the terminal screw 20 is screwed to the L-shaped one end 16a of the primary circuit terminal 16, and the other end 16b is electrically and mechanically connected with the bimetal support member 21 by means of welding. In this case, an upper end portion of the bimetal 2 is electrically and mechanically joined and fixed to the tongue portion 21a of the bimetal support member 21.

Concerning the primary circuit terminal 15 on the electric power supply side, one end 15a of the primary circuit terminal 15 is electrically connected with an upper end portion 3a of the heater 3 by means of welding, and the other end 15b of the primary circuit terminal 15 is screwed to the terminal of the electric power supply circuit such as an electromagnetic contactor (not shown).

The heater support member 22 made of heat-resistant resin holds the primary circuit terminal 15 on the electric power supply side when the primary circuit terminal 15 is held by the first groove section 22a of the heater support member 22. The heater support member 22 also holds the tongue portion 21a of the bimetal support member 21 and the upper end portion of the bimetal 2 when the tongue portion 21a of the bimetal support member 21 and the upper end portion of the bimetal 2 are held by the second groove section 22b of the heater support member 22. The cylindrical pin 22c formed at the right end of the heater support member 22 is inserted into the hole 21c formed at the upper end portion of the bimetal support member 21.

As shown in FIGS. 3A to 3D, the heater support member 22 has a function of integrating the electric power supply side primary circuit terminal 15, the bimetal support member 21, the bimetal 2 and the parts such as a heater 3 and others, which are incorporated to the primary circuit and the heating element circumference parts, into one body.

The heating element, which is integrated into one body as described above and assembled as shown in FIGS. 3A to 3D, is accommodated in the case 1. At this time, a forward end portion of the pin 22c of the heater support member 22 is inserted into the hole 1×of the case 1. Under the condition that the heater support member 22 can be rotated round the pin 22c, an adjustment is made so that a forward end portion of the bimetal 2 can be set at the same mutual position of each phase, and then the lower end portion 21b of the bimetal support member 21 is fixed to the case 1 by the fastening screw 19.

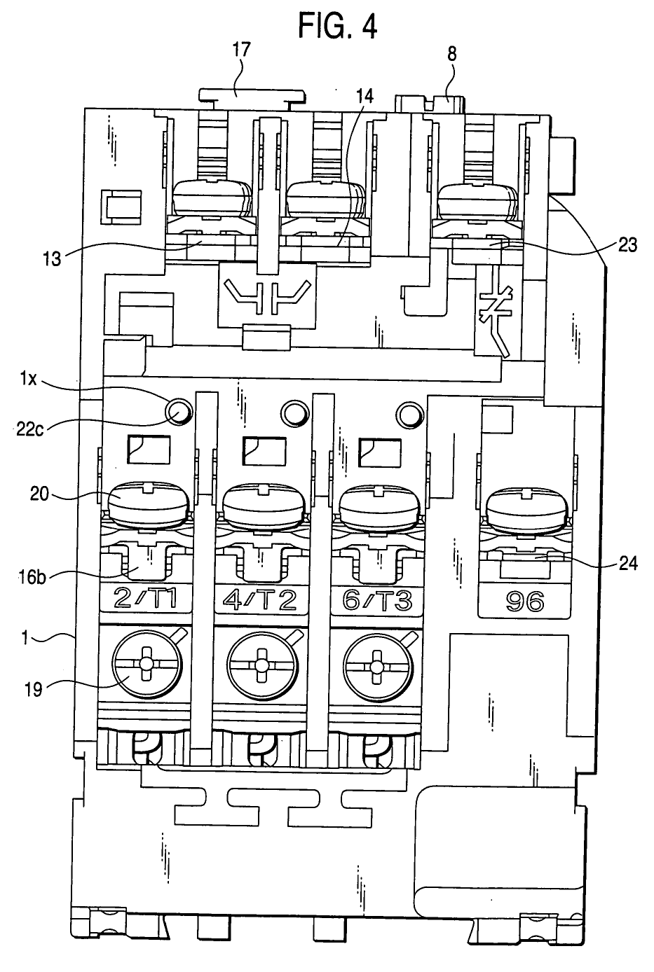

FIG. 4 is a view showing an appearance of the terminal section of the thermal overcurrent relay. In the view, the fixing side terminal 23 always closed and the movable side terminal 24 always closed are press-fitted and fixed into the case 1.

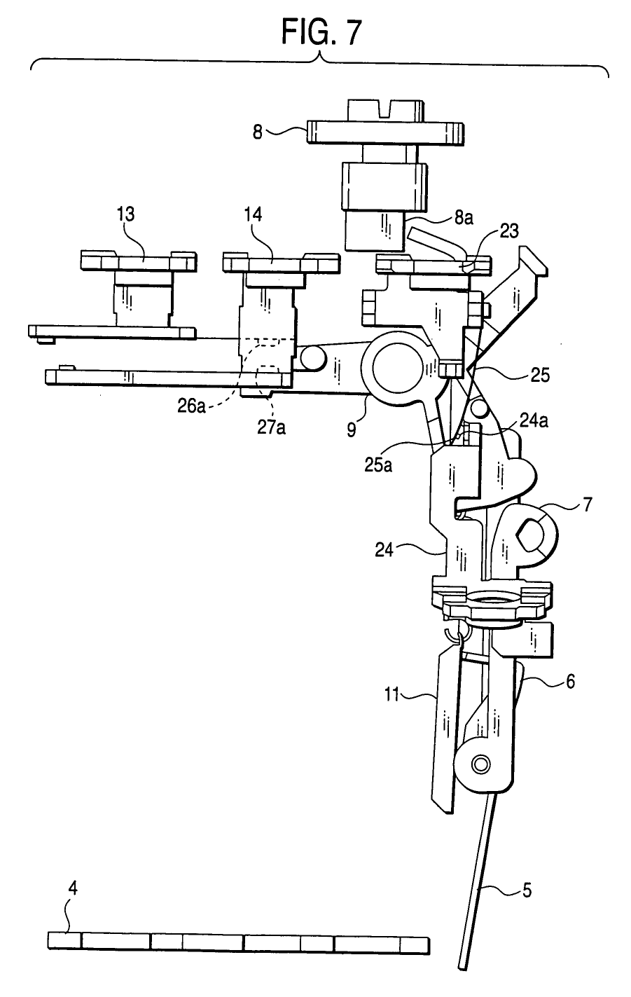

Concerning the structure of the contact always closed, as shown in FIG. 7, the movable side terminal 23 always closed includes the movable contact 25 always closed which is composed of an elastic and conductive metal sheet and electrically and mechanically connected and fixed to the movable side terminal 23 always closed by means of calking.

In an upper portion of the fixing side terminal 24 always closed, the fixing contact 24a is arranged in such a manner that it is opposed to the contact 25a of the movable contact 25 always closed. The movable contact 25 always closed has a spring force so that it can be contacted with the fixing contact 24a when an external force is not given to it.

When these contacts 25a and 24a, which are closed and opened, are provided, the contact always closed is composed.

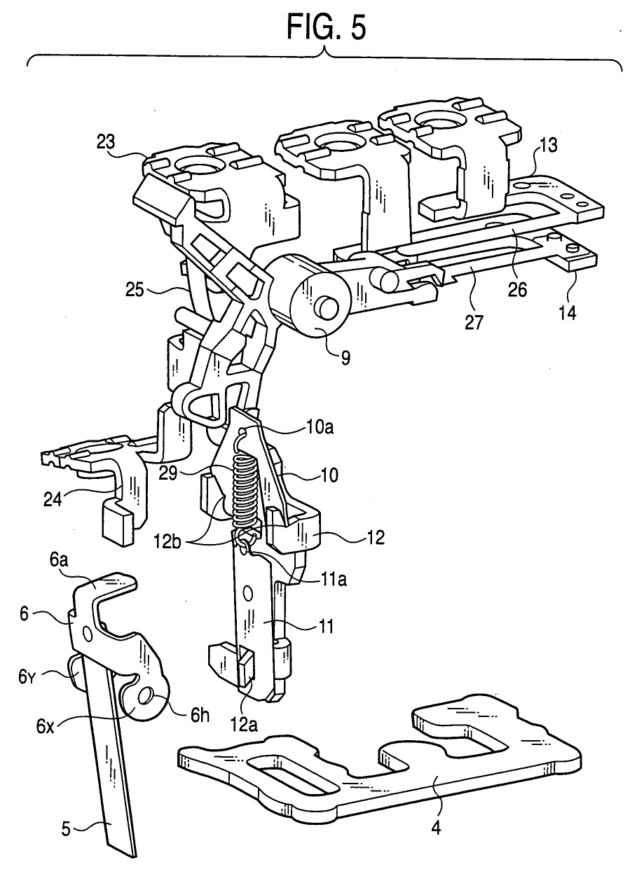

FIGS. 5 to 11 are arrangement views showing the internal structure in detail.

In the views, reference numerals 26 and 27 are respectively a fixing contacting piece always open and a movable contacting piece always open which are respectively composed of an elastic and conductive metal sheet and electrically and mechanically connected and fixed to the fixing side terminal 13 always open and the movable side terminal 14 always open by means of calking at the right end portions.

In the fixing contacting piece 26 always open and the movable contacting piece 27 always open, at a respective end portion on the opposite side to the side of calking, the contacts 26a and 27a are arranged so that they can be opposed to each other. When the contacts 26a and 27a are arranged so that they can be opened and closed, the contact always open is composed.

The movable contacting piece 27 always open is operated by the rotary lever 9 and opens and closes the contact always open being interlocked with the inverting mechanism section.

The operation lever 6 is composed of the L-shaped plate 6a and two side plates 6×, 6y which are connected with the L-shaped plate 6a. On the respective side plates 6×, 6y, there is formed a shaft hole 6h penetrating the side plates 6×, 6y.

At the lower central portion of the L-shaped plate 6a, an upper portion of the ambient temperature compensation bimetal 5 is fixed by means of welding, and the operation lever 6 and the ambient temperature compensation bimetal 5 are integrated into one body.

In a lower portion of the adjusting lever 7, there is formed a shaft hole 7h penetrating two sheets 7x, 7y composing the adjusting lever. The pin 28 is coaxially inserted into the shaft hole 6h of the operation lever 6 and the shaft hole 7h of the adjusting lever 7.

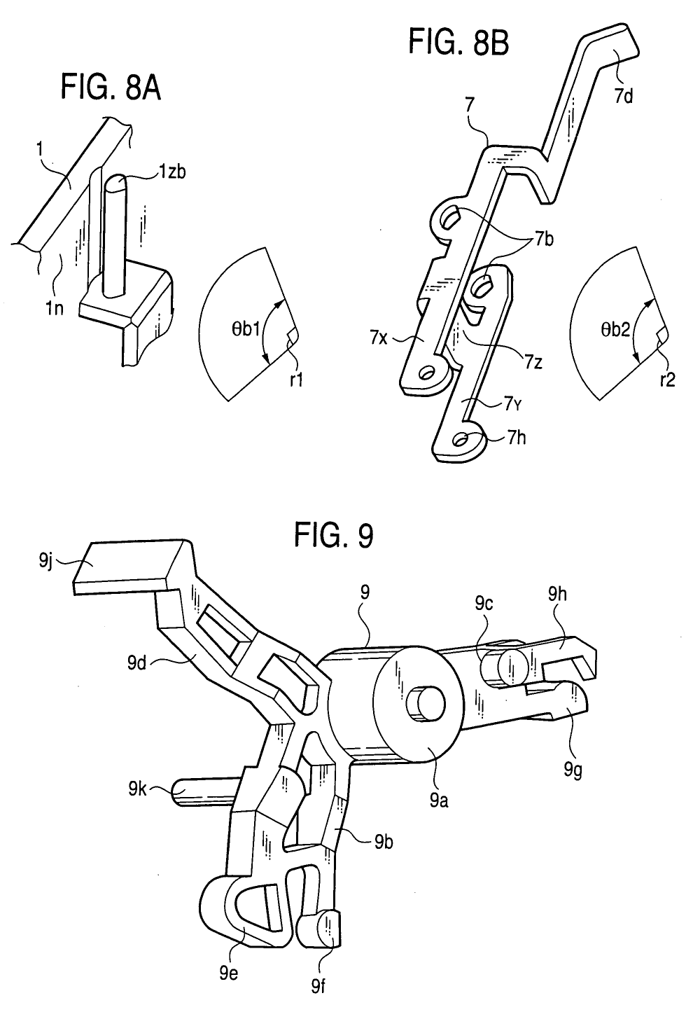

In this connection, as shown in FIGS. 8A and 8B, the adjusting lever 7 is supported by the substantially sectorial projection shaft 1zb which protrudes from the case 1 and has an acute central angle θb1 (for example, 110°) formed in the form opening toward an inner wall in of the case which is present in the travelling direction of the interlocking plate 4, wherein the end portion of the substantially sectorial shaft 1zb is formed into an arc of a minute radius (r1=0.2 mm). The adjusting lever 7 is composed of two plates 7x, 7y perpendicular to the support shaft 1zb and one connecting plate 7z connected to the two plates 7x, 7y while the connecting plate 7z is crossing the two plates 7x, 7y. This adjusting lever 7 is formed into a substantial C-shape.

On the respective two plates 7x, 7y composing the adjusting lever, there is formed a substantially sector-shaped shaft hole 7b which has an acute central angle θb2 (for example, 140°) in the same manner as that of the above adjusting lever support shaft and has an arc portion of a minute radius at the forward end portion of the angle. In this case, the central angle θb1 of the support shaft is smaller than the central angle θb2 of the shaft hole, and further the radius of the arc at the acute angle end portion of the support shaft 1zb is larger than the radius (r2=0.17 mm) of the acute angle end portion of the shaft hole 7b.

The support shaft 1zb protruding from the case 1 is inserted into the substantially sectorial shaft hole 7b respectively formed on the two sheets 7x, 7y composing the adjusting lever 7, and the adjusting lever. 7 rotates round the fulcrum portion of the support shaft 1zb.

The adjusting knob 8 is pivotally attached to the case 1. The eccentric cam section 8a of the adjusting knob 8 is formed in such a manner that the radius is gradually reduced according to the rotation of the adjusting knob 8.

In FIG. 1, when the lower end portion of the ambient temperature compensation bimetal 5 is pushed by the left end portion of the interlocking plate 4, the operation lever 6 and the adjusting lever 7 are rotated clockwise. When the adjusting lever 7 is rotated in a predetermined range, the protruding portion 7d formed at the upper end portion of the adjusting lever 7 comes into contact with the eccentric cam section 8a of the adjusting knob 8, and rotation of the adjusting lever 7 is restricted.

Since a distance of the movement of the adjusting lever 7 until the eccentric cam section 8a comes into contact with the protruding portion 7d formed at the upper end portion of the adjusting lever 7 is changed when the adjusting knob 8 is rotated, when the adjusting knob 8 is previously rotated to an arbitrary position, the rotational range of the adjusting lever 7 can be arbitrarily changed according to the position of the knob. In this connection, a quantity of pushing given to the inverting mechanism section necessary for inverting an opening and closing state of the contact is determined by a total of the quantity of rotation of the operation lever 6 and the adjusting lever 7.

When a quantity of rotation of the adjusting lever 7 is restricted, it is possible to change a quantity of rotation of the operation lever 6 necessary for inverting an opening and closing state of the contact, which means that a quantity of displacement of the interlocking plate 4 necessary for inverting the opening and closing state of the contact is changed.

This quantity of displacement of the interlocking plate 4 corresponds to a quantity of curve of the bimetal 2. Since the quantity of curve of the bimetal 2 is determined by an intensity of the operation current, it is possible to arbitrarily adjust the inverting position according to the intensity of the operation current.

The substantially Y-shaped rotary lever 9 is pivotally held by the protruding shaft 1z arranged in the case 1 when the cylindrical portion 9a of the rotary lever 9 is inserted into the protruding shaft 1z.

The substantially Y-shaped rotary lever 9 is composed of the first arm 9b, the second arm 9c and the third arm 9d which are respectively extended in the three directions from the above cylindrical portion 9a. A forward end portion of the first arm 9b is divided into the two protruding pieces 9e and 9f. These two protruding pieces 9e and 9f hold an upper end portion of the inverting plate 10.

At a substantially intermediate portion of the first arm 9b, there is provided a protruding portion 9k for driving the contact piece 25 always closed. In the initial state, the protruding portion 9k and the contact piece 25 always closed are arranged so that a predetermined clearance can be formed.

A forward end portion of the second arm 9c is also divided into two protruding pieces 9g and 9h. These two protruding pieces 9g and 9h are arranged so that a left end portion of the movable contact piece 27 always open can enter between the two protruding pieces 9g and 9h.

A forward end portion of the third arm 9d is formed into the bent display piece 9j as shown in FIG. 9. This display piece 9j protrudes in the direction of the window 1w of the case 1.

When the inverting mechanism section is inverted, the rotary lever 9 is rotated, and the contact always closed is opened by the protruding piece 9k. When the movable contact piece 27 always closed is raised by the protruding piece 9g, the contact always open is closed.

Accordingly, an opening and closing state of the contact can be confirmed by checking whether or not the display piece 9j can be seen through the window 1w.

The inverting mechanism support member 12 includes: a first fulcrum 12a arranged at the lower portion; and a second fulcrum 12b arranged at the upper portion.

The edge portion 11e formed on the operation plate 11 comes into contact with the first fulcrum 12a of the inverting mechanism support member 12, and the edge portion 10e formed on the inverting plate 10 comes into contact with the second fulcrum 12b of the inverting mechanism support member 12. The tension coil spring 29 is provided between the hole 11a formed in an upper portion of the operating plate 11 and the hole 10a formed in an upper portion of the inverting plate 10.

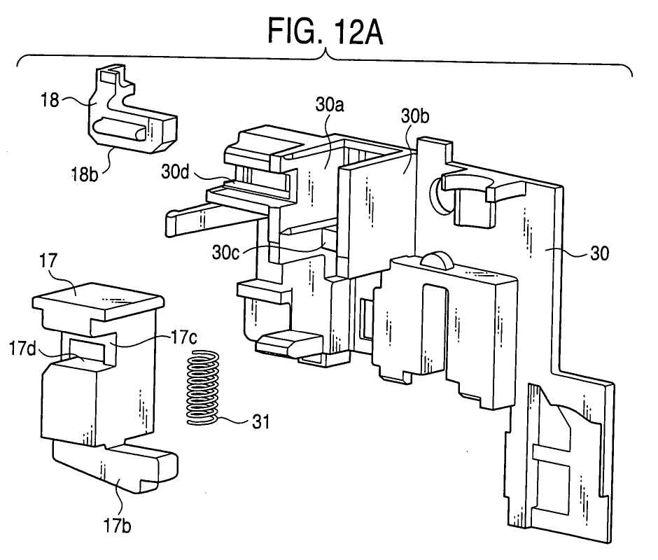

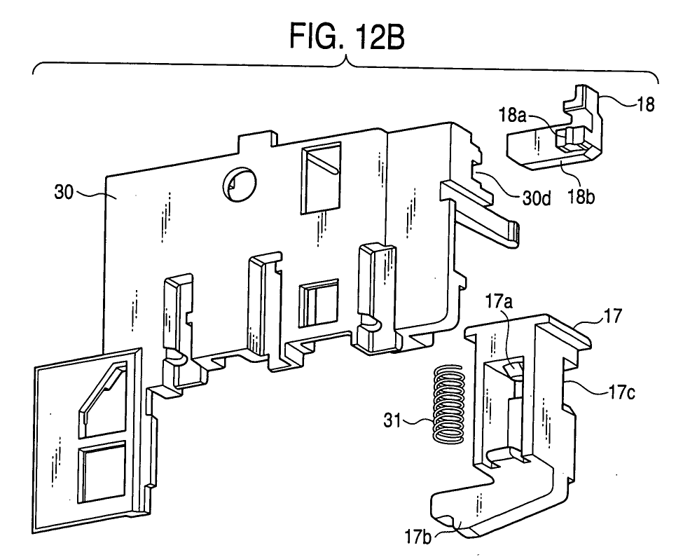

FIGS. 12A and 12B are views showing the structure of a reset bar case which is attached to the case after the reset bar and the changeover plate were incorporated to the reset bar case.

In the views, both sides of the reset bar 17 are slidably supported by the guides 30a and 30b of the reset bar case 30. The reset bar 17 is arranged so that it can be moved in the vertical direction in FIG. 1. The return spring 31 is incorporated being compressed into between the spring receiving portion 17a and the spring receiving portion 30c provided in the reset bar case 30. The reset bar 17 is pushed upward by the return spring 31. The protrusion 17b formed at the lower portion of the reset bar 17 is arranged so that it can push an upper face of the fixing contacting piece 26 always open.

The changeover plate 18 is incorporated into the reset bar case 30 in such a manner that the protrusion 18a formed on the side of the changeover plate 18 is embedded in the groove 30d of the reset bar case 30. When the changeover plate 18 is moved to right and left along the groove 30d of the reset bar case 30, the reset system can be changed over between the manual reset and the automatic reset after the contact of the device has been operated.

The state shown in FIG. 1 is a state in which the reset operation is manually conducted.

In the case of the automatic reset, when the changeover plate 18 is moved to left in FIG. 1, the changeover plate 18 is inserted into the recess portion 17c of the reset bar 17. When the reset bar is moved downward by a distance corresponding to the difference of the height of the lower face 18b of the changeover plate 18 and the height of the changeover plate contacting face 17d of the recess portion 17c of the reset bar 17, the protrusion 17b of the lower portion of the reset bar 17 pushes down the upper face of the fixing contact piece 26 always open by a predetermined distance. Therefore, the contact always open, which is once closed, is automatically opened because no force is given from the bimetal 2.

Next, operation of the thermal overcurrent relay of the embodiment of the present invention will be explained below.

In FIG. 1, in the case of an overload, since an intensity of the electric current in the primary circuit is increased, the bimetal 2 is greatly curved. Therefore, the interlocking plate 4 is pushed by the forward end of the bimetal 2 and moved to left. Accordingly, the lower end portion of the ambient temperature compensation bimetal 5 is pushed to left by the left end portion of the interlocking plate 4.

In this case, since the ambient temperature compensation bimetal 5 is fixed to the operation lever 6, when the ambient temperature compensation bimetal 5 is pushed by the interlocking plate 4, the operation lever 6 is rotated clockwise round the connecting pin 28 by which the operation lever 6 is connected with the adjusting lever 7.

At the same time, the adjusting lever 7 is also rotated clockwise until it comes into contact with the eccentric cam section 8a of the adjusting knob 8.

When rotation of the adjusting lever 7 is restricted, a position of the connecting pin 28, which is a rotational center of the operation lever 6, is not moved any more. Therefore, the operation lever 6 is rotated round the connecting pin 28 and pushes the operation plate 11 clockwise.

When the L-shaped plate 6a of the operation lever 6 pushes the operation plate 11 clockwise, the operation plate 11 is rotated clockwise round the first fulcrum 12a of the inverting mechanism support member 12.

Due to the above operation, the hole 11a of the operation plate 11 is moved to right in FIG. 1. When the operation plate 11 is rotated to a state (dead point) in which the tension coil spring 29, which connects the hole 11a of the operation plate 11 with the hole 10a of the inversion plate 10, exceeds a straight line, which connects the hole 10a of the inversion plate 10 with the second fulcrum 12b of the inverting mechanism support member 12, to right, a tensile force of the tension coil spring 29 acting on the inversion plate 10 is inverted clockwise round the second fulcrum 12b of the inverting mechanism support member 12. Therefore, the inversion plate 10 quickly conducts a clockwise rotating motion (trip motion).

Until the state changes to this dead point, the tensile force of the tensile coil spring 29 is given to the inversion plate 10 as a counterclockwise force acting round the second fulcrum 12b of the inverting mechanism support member 12.

When the inversion plate 10 is rotated clockwise by exceeding the dead point, the protruding piece 9f of the rotary lever 9 is pushed to right by the upper end portion of the inversion plate 10. Therefore, the rotary lever 9 is rotated counterclockwise round the protruding shaft 1z of the case 1.

At this time, the movable contact piece 25 always closed is pushed and deformed by the protruding portion 9k of the rotary lever 9, and the contact 25a is separated and opened by the fixing contact 24a always closed, and the circuit is opened.

When the movable contact piece 27 always open is pushed by the protruding piece 9g of the rotary lever 9, it is deformed, and the contact 27a comes into contact with the contact. 26a of the fixing contacting piece 26 always open, and the circuit is closed.

When heat generated by the heater 3 is sufficiently dissipated in the above state (trip state) in which the inverting motion is completed, deformation of the curved bimetal 2 returns to the initial state.

In this case, when the reset bar 17 is manually pushed downward resisting an elastic force of the return spring 31, the protrusion 17b of the lower portion of the reset bar 17 pushes an upper face of the fixing contact piece 26 always open, so that the fixing contacting piece 26 always open is pushed downward.

Since the contact 26a of the fixing contacting piece 26 always open and the contact 27a of the movable contacting piece 27 always open are contacted with each other in the trip state, when the fixing contact piece 26 always open is pushed downward, the protruding piece 9g of the second arm 9c of the rotary lever 9 is also pushed downward via the movable contacting piece 27 always open.

Due to the foregoing, the rotary lever 9 is rotated clockwise round the protruding shaft 1z of the case 1, and the inversion plate 10 is pushed by the protruding piece 9f of the first arm 9b and moved to left.

When the hole 10a on the inversion plate 10 is moved to left with respect to a straight line connecting the first fulcrum 12a of the inverting mechanism support member. 12 with the second fulcrum 12b, a tensile force of the tension coil spring 29 acting on the inversion plate 10 is inverted counterclockwise round the second fulcrum 12b of the inverting mechanism support member 12. Therefore, the inversion plate 10 quickly conducts a counterclockwise rotating motion (reset motion).

When the inversion plate 10 conducts the reset motion, an upper end portion of the inversion plate 10 pushes the protruding piece 9e of the first arm of the rotary lever 9 to left, and the rotary lever 9 is rotated clockwise by a force of the inversion plate 10 round the protruding shaft 1z of the case 1.

Accordingly, it is sufficient for the reset bar 17 to push down the fixing contact piece 26 always open to a position where the inversion plate 10 starts the reset motion. After that, the reset bar 17 is returned to the initial state by an elastic force of the return spring 31.

The rotary lever 9 is rotated clockwise by a force given from the inversion plate 10 and returned to the initial state (reset state). Therefore, the contact always open is opened, and the contact always closed is closed. In this connection, the above explanations are made into the reset system in which the reset operation is manually conducted.

In the case where the reset operation is automatically conducted, the changeover plate 18 is inserted into the recess portion 17c of the reset bar 17, so that the reset bar 17 is moved downward, and the reset bar 66 is fixed while the fixing contacting piece 26 always open is pushed down by the protruding portion 17b.

Accordingly, when the heater 3 is cooled, a tension force of the tension coil spring 29 acting on the inversion plate 10 is automatically inverted from clockwise to counterclockwise. Therefore, even when the reset bar 17 is not manually pushed, the reset motion is automatically conducted.

Next, explanations will be made into a rotary motion conducted round the shaft 1zb of the adjusting lever 7 of the thermal overcurrent relay of the present invention.

In this embodiment, a difference in the angle between the central angle θb2 of the substantially sectorial shaft hole of the adjusting lever 7 and the central angle θb1 of the substantially sectorial shaft for supporting the adjusting lever 7 is approximately the same as the predetermined rotating range of the adjusting lever 7 according to the range of the usable primary circuit current. Therefore, the adjusting lever 7 is suppressed so that it can not be unnecessarily rotated.

Concerning the relation between the radius r2 on the central angle θb2 side of the substantially sectorial shaft hole of the adjusting lever 7 and the radius r1 on the central angle θb1 side of the substantially sectorial shaft for supporting the adjusting lever 7, the radius r1 of the support shaft 1zb is larger than the radius r2 of the shaft hole.

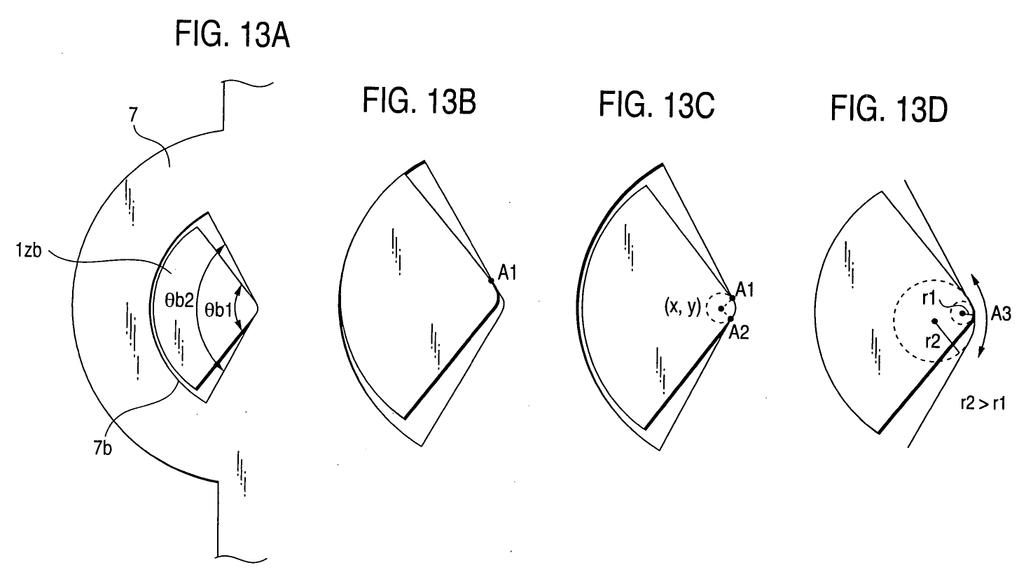

In this case, when no overload is given and no abnormal electric current flows in the thermal overcurrent relay, as shown in FIG. 13A, a difference in the size exists between the support shaft 1zb of the adjusting lever 7 and the shaft hole 7b so that the occurrence of interference can be avoided. Due to existence of this difference in the size, the adjusting lever 7 freely jounces.

However, when an overload is given, the bimetal 2 is curved and the interlocking plate 4 is moved to left in FIG. 1 so that the ambient temperature compensation bimetal 5 is pushed to left. In this case, the adjusting lever 7 is also pushed to left.

As a result, as shown in FIG. 13B, an arc of the forward end portion of the acute angle of the adjusting lever support shaft 1zb comes into contact with any wall face of the inner wall V-shaped portion in the shaft hole 7b. The contact in this case is represented by A1. Further, when a force is given to left by the interlocking plate 4, the contact A1 slides and finally the support shaft 1zb comes into contact at the two points of the contacts A1 and A2 as shown in FIG. 13C.

As described above, the arc of the forward end portion of the acute angle of the adjusting lever support shaft 1zb comes into contact with the inner wall V-shaped portion of the adjusting lever shaft hole 7b at two points. After that, the adjusting lever 7 is rotated round the point (x, y) at which two normal lines, which respectively pass through the two contact points A1 and A2 located on the arc of the forward end portion of the acute angle of the support shaft 1zb, cross each other. In the case of an overload, the bimetal 2 is curved. Therefore, the adjusting lever 7 is always given a force to left. Therefore, the adjusting lever shaft hole 7b always comes into contact with the arc of the forward end of the acute angle of the support shaft 1zb at the two points. Accordingly, the rotational center (x, y) is always positioned at the same place. For the above reasons, no jounce is caused in the adjusting lever 7 and positioning can be positively conducted.

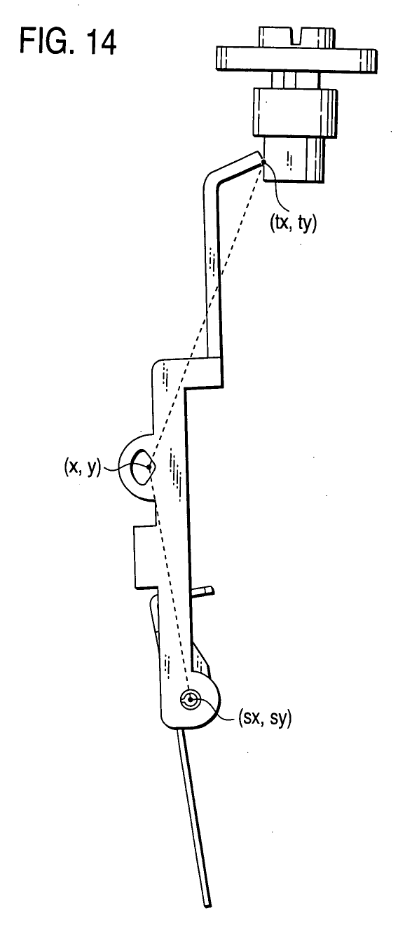

When the rotational center (x, y) of the adjusting lever 7 is determined at the same position, after the knob 8 is previously rotated to an arbitrary position and kept at the position, as shown in FIG. 14, the contacting point (tx, ty) of the protrusion 7d formed at the upper end portion of the adjusting lever 7 with the eccentric cam portion 8a of the adjusting knob 8 and the central coordinate (sx, sy) of the connecting pin 28, which becomes a rotational center of the operation lever 6 provided in the adjusting lever 7, are respectively determined at the same positions. Therefore it becomes possible to open and close the contact at a targeted position. Accordingly, it is possible to provide a highly accurate adjusting mechanism, the operation property of which seldom fluctuates.

On the other hand, as shown in FIG. 13D, when the radius r1 on the central angle θb1 side of the adjusting lever support shaft 1zb is smaller than the radius r2 on the central angle θb2 side of the adjusting lever shaft hole 7b, the support shaft 1zb and the shaft hole 7b are not contacted with each other at two points but they are contacted with each other at one point. Therefore, the contacting point A3 can be freely moved in the V-shaped portion on the inner wall of the shaft hole 7b and in the arc portion. Accordingly, the rotational center can not be determined and the position of the adjusting lever 7 can not be positively determined.

Since the adjusting lever 7 is composed of the two plates, one is an upper plate and the other is a lower plate, a straight line connecting the rotational centers of the respective two plates can be positively determined at the same position as the central axis of rotation of the adjusting lever 7. Therefore, it is possible to provide a highly accurate adjusting mechanism in which no jounce is caused in the vertical and the horizontal direction and further no jounce is caused in the direction perpendicular to the vertical and the horizontal direction. Therefore, it is possible to provide a highly accurate adjusting mechanism.

A difference in the angle between the substantially sectorial shaft hole central angle θb2 of the adjusting lever 7 and the substantially sectorial support shaft central angle θb1 for supporting the adjusting lever 7 is formed by giving consideration to a predetermined rotating range of the adjusting lever 7 according to the usable range of the primary circuit current. Accordingly, it is possible to prevent the adjusting lever 7 from being rotated to an unnecessarily wide range. Therefore, it is possible to prevent deformation of the operation plate caused when the adjusting lever 7 is excessively pushed. Consequently, it is possible to provide a highly accurate adjusting mechanism in which the operation property seldom fluctuates.

Embodiment 2

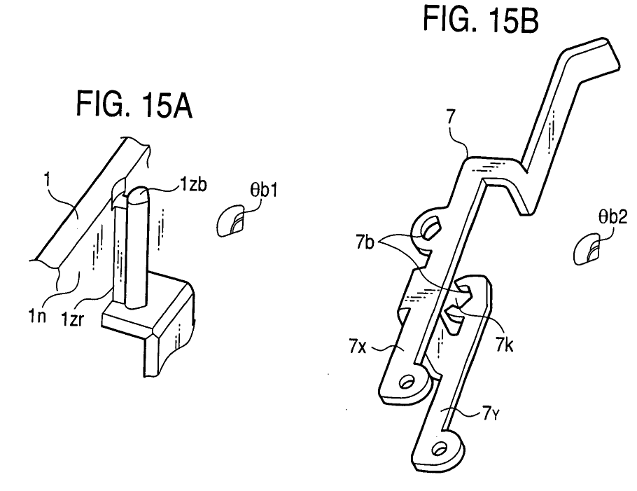

Referring to FIGS. 15A and 15B, an embodiment of the thermal overcurrent relay of the present invention will be explained below.

This embodiment is composed in such a manner that the shaft 1zb protruding from the case 1 is connected with the inner wall in of the case by the rib 1zr, the width of which is smaller than the diameter of the shaft 1zb, except for the upper portion of the shaft 1zb, in the thermal overcurrent relay of Embodiment 1.

On the other hand, concerning the plate 7y, which is one of the two plates composing the adjusting lever 7 and arranged close to the root portion of the shaft 1zb, a profile of the engaging portion of the plate 7y with the shaft 1zb is formed into a reverse C-shape having the cutout portion 7k, the size of which is larger than the width of the rib 1zr and smaller than the diameter of the shaft 1zb. Even when the adjusting lever 7 conducts a predetermined rotation according to the usable range of the primary circuit current, the adjusting lever 7 does not interfere with the rib 1zr. Further, the adjusting lever 7 has a hook portion in which the adjusting lever 7 is always hooked at the shaft 1zb.

Accordingly, while the adjusting lever support shaft 1zb is being prevented from tilting, the adjusting lever 7 does not interfere with the rib and further the adjusting lever 7 always has a hook portion at which the adjusting lever 7 is hooked at the support shaft 1zb. Therefore, the adjusting lever 7 can not come out to right and left. Accordingly, it is possible to prevent fluctuation of the operation property caused by the tilt of the support shaft 1zb, and further it is possible to prevent fluctuation of the operation property caused by the tilt of the adjusting lever 7.

Embodiment 3

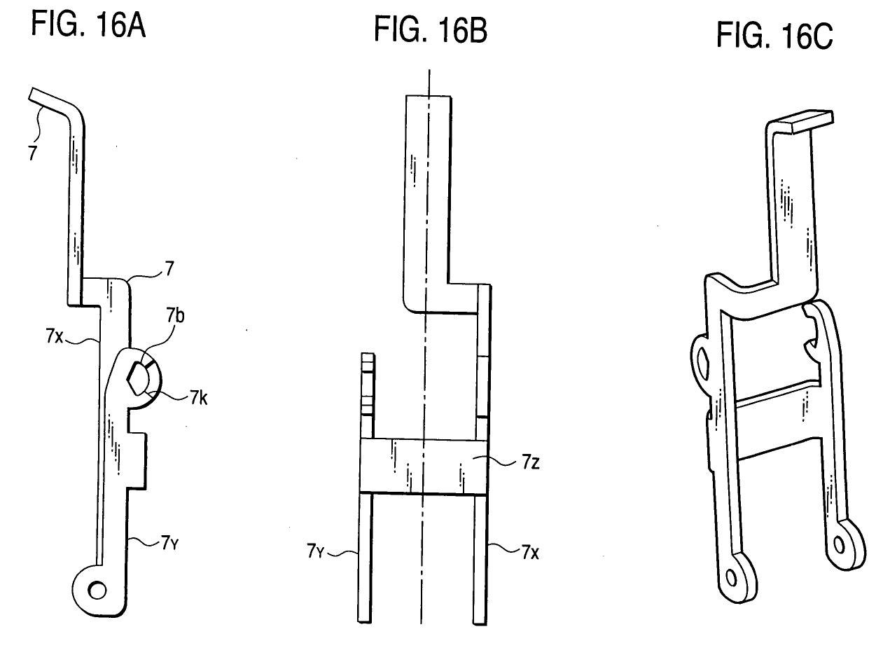

In this embodiment, as shown in FIGS. 16A to 16C, at the substantial center of the two plates 7× and 7y of the adjusting lever 7, there is provided a protruding portion 7d which comes into contact with the eccentric cam portion 8a of the adjusting knob 8.

Therefore, a force, the direction of which is perpendicular to the adjusting lever support shaft 1zb, is given from the interlocking plate 4 to the adjusting lever 7. Accordingly, no twist is caused when the adjusting lever 7 is rotated. Consequently, it is possible to provide a highly accurate adjusting mechanism, the operation property of which seldom fluctuates.

Embodiment 4

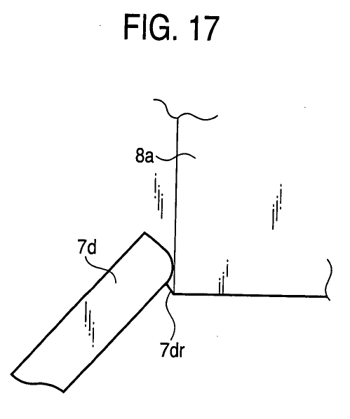

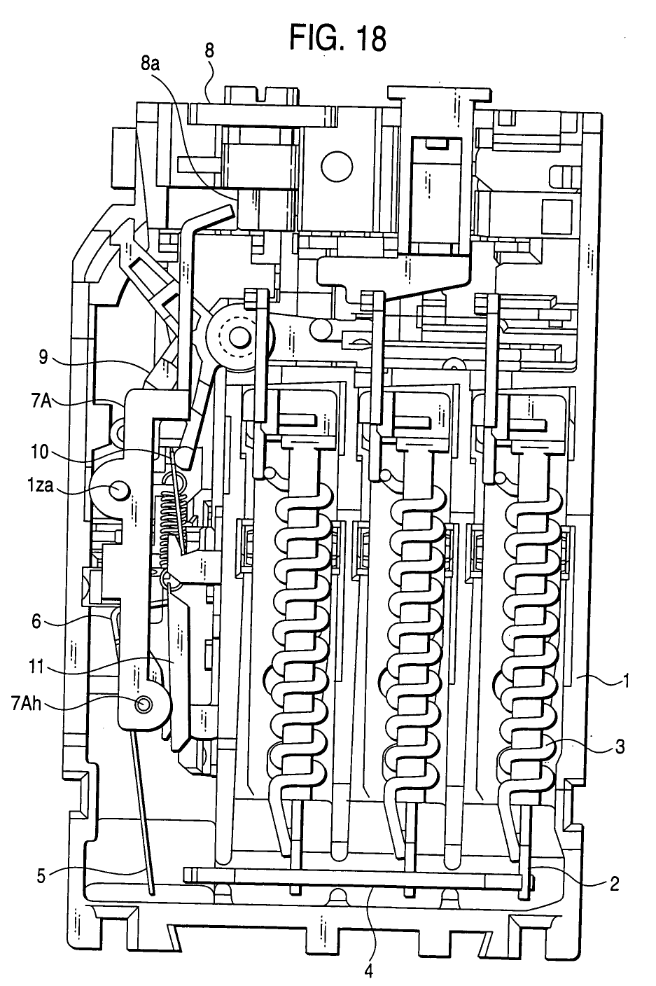

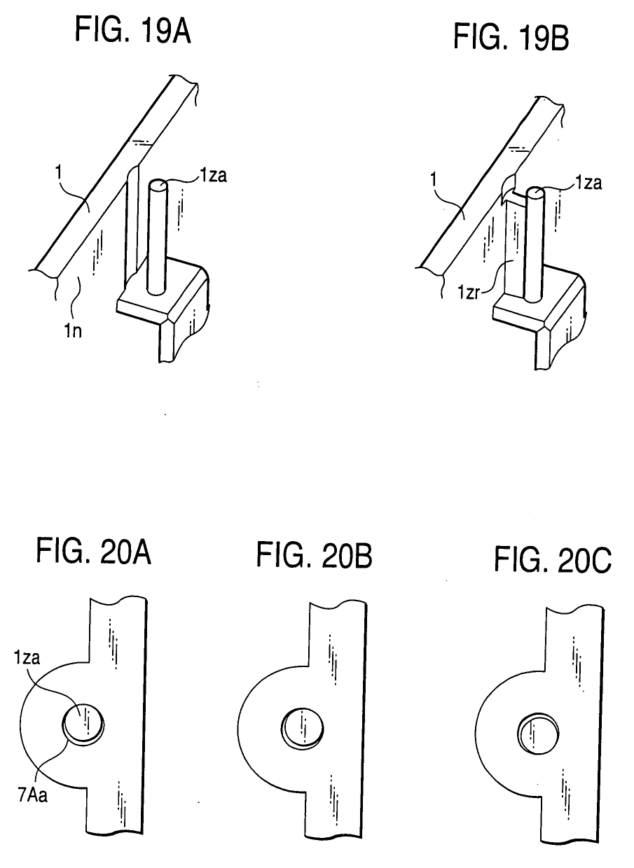

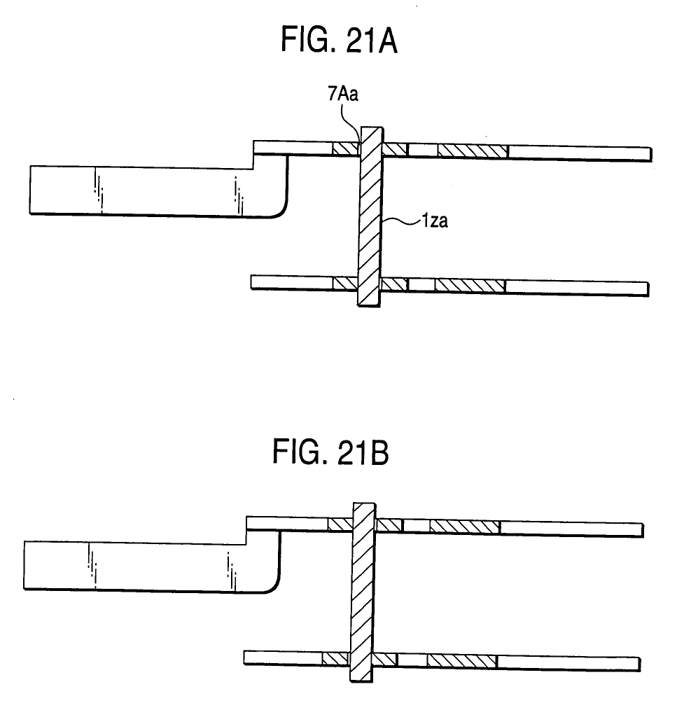

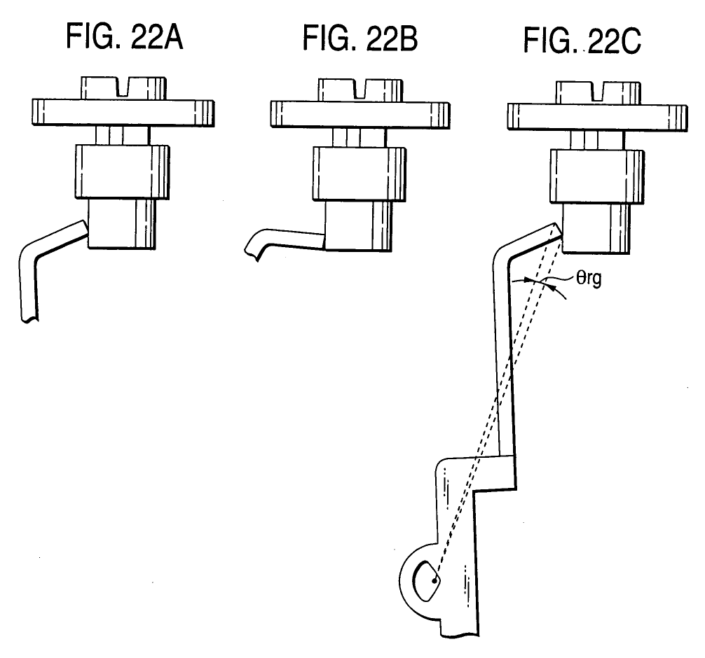

In this embodiment, as shown in FIG. 17, the adjusting lever 7 is composed as follows. The arc portion 7dr is formed in the protruding portion 7d formed in the upper end portion of the adjusting lever 7. In the predetermined rotational range of the adjusting lever 7, the adjusting lever 7 always comes into contact with the eccentric cam portion 8a of the adjusting knob 8 at this arc portion 7dr. Therefore, it is possible to avoid the existence of an unstable contacting position in the process of adjustment. Therefore, it is possible to provide an adjusting mechanism, the operation property of which does not fluctuate and the operation accuracy of which is high.

### INDUSTRIAL APPLICABILITY

As described above, the thermal overcurrent relay of the present invention is preferably used for suppressing fluctuation of the operation property of the thermal overcurrent relay that conducts a trip motion for the object of protecting a motor and others from being given an overload.

1. A thermal overcurrent relay comprising:
a bimetal curved according to a primary circuit current;
an interlocking plate for transmitting a displacement of the bimetal;
an adjusting lever supported by a shaft protruding from a case, freely rotating in a predetermined range according to a range of the primary circuit current capable of being used;
an operation lever supported by the adjusting lever, rotated by a force given from the interlocking plate, acting on an inverting mechanism section to invert an opening and closing state of a contact; and
an adjusting knob for changing a distance of the displacement of the interlocking plate necessary for the start. of inversion, wherein
the support shaft of the adjusting lever is a substantially sectorial protrusion, the sectional profile of which has a central angle open to an inner wall of the case existing in the proceeding direction of the interlocking plate, and the adjusting lever has a substantially sectorial shaft hole, which is inserted into the support shaft, having an angle larger than the central angle of the support shaft.

2. The thermal overcurrent relay according to claim 1,
wherein a sectional profile of the adjusting lever support shaft is a sector, in the central angle portion of which an arc of a minute radius is formed, and the adjusting lever support shaft comes into contact with an inner wall face of a shaft hole of the adjusting lever at two points on the arc of the minute radius.

3. The thermal overcurrent relay according to claim 1 or 2, wherein
the adjusting lever is formed into a substantial C-shape composed of two plates, which are perpendicular to the support shaft, and one connecting plate to connect the two plates in such a manner that the connecting plate crosses the two plates, and the two plates of the adjusting lever inserted into the support shaft respectively have a substantially sectorial shaft hole.

4. The thermal overcurrent relay according to one of claims 1 to 3, wherein
a difference between the central angle of the adjusting lever support shaft and the central angle of the shaft hole is approximately the same as the angle of the predetermined rotating range of the adjusting lever according to the range of the usable primary circuit current.

5. The thermal overcurrent relay according to one of claims 1 to 4, wherein
the adjusting lever support shaft protruding from the case is connected with the inner wall of the case except for an upper portion of the support shaft by a rib, the width of which is smaller than the diameter of the adjusting lever support shaft protruding from the inner wall of the case existing in the proceeding direction of the interlocking plate, the engaging portion of the plate close to the root of the adjusting lever support shaft with the support shaft is formed into a reverse C-shape having a cutout portion, the size of which is larger than the width of the rib connected with the support shaft and smaller than the diameter of the support shaft, and the adjusting lever does not interfere with the rib even when the adjusting lever makes a predetermined rotation according to the range of the usable primary circuit current and the adjusting lever always has a hook portion at which the support shaft is hooked.

6. The thermal overcurrent relay according to one of claims 1 to 5, wherein
the contacting portion of the adjusting lever with the adjusting knob is located at a substantial center between the two plates composing the adjusting lever perpendicular to the adjusting lever support shaft.

7. The thermal overcurrent relay according to one of claims 1 to 6, wherein
an arc portion is formed on the protruding portion formed on the upper end portion of the adjusting lever, and the adjusting lever is composed so that it can be always contacted with the eccentric cam portion of the adjusting knob on the arc portion in a predetermined rotational range of the adjusting lever.
